(19) United States
(12) Patent Application Publication
(10) Pub. No.: US 2003/0063070 A1
(43) Pub. Date: Apr. 3, 2003

(54) Keyboard optimized for use with the thumbs and handheld electronic device having the same

(76) Inventor: Beng Hong Alex Kang, Singapore (SG)

Correspondence Address: HEWLETT-PACKARD COMPANY, Intellectual Property Aministration, P.O. Box 272400, Fort Collins, CO, 80527-2400, US

(21) Appl. No.: 10/053,471

(22) Filed: Nov. 2, 2001

(30) Foreign Application Priority Data
Oct. 2, 2001 (SG) 200106103-5

(51) Int. Cl. G09G 5/00

(52) U.S. Cl. 345/168

(57) ABSTRACT

A keyboard suitable for a handheld device that includes a plurality of elongated keys arranged along at least one row is disclosed. The row laterally extends from an origin. Each of the plurality of keys is inclined at an angle from a normal. The angle of incline of each of the plurality of keys increases with distance between the key and the origin. Preferably, each of the plurality of keys has an asymmetrical shape that is bulbous at one end and narrow at an opposite end. A handheld electronic device that includes the above keyboard is also disclosed.

### BACKGROUND

This invention relates to a keyboard suitable for use on a handheld device or peripheral. More particularly, this invention relates to the shape and layout of keys of a keyboard for a handheld device or peripheral that is optimized especially for thumb typing.

Standard keyboards have been provided for data entry on handheld electronic devices such as personal digital assistants (PDAs), two-way pagers and the like. These standard keyboards are either miniaturized mechanical keyboards, such as those disclosed in U.S. Pat. No. 6,278,442 and U.S. Design Pat. No. 386,497, or graphical keyboards that are displayed on a touch sensitive screen. Although these keyboards work, they suffer from disadvantages.

Although the graphical keyboard is visually analogous to a full-sized mechanical keyboard, it is functionally far more limited. With a graphical keyboard, a user cannot “touch type” using thumbs of both hands, but instead must “hunt and peck” with a pen or stylus. Typing speed on the graphical keyboard is constrained by the time required for the user to move the finger/stylus from key to key on the keyboard. Also, the user cannot tap multiple keys simultaneously. In particular, the user cannot tap a modifier key, such as the “shift,” “ctrl,” “option,” or “alt” key, at the same time as an ordinary key, such as a letter or number key, but instead must first tap the modifier key and then tap the letter or number key. Another problem with the graphical keyboard is that it tends to take up a large portion of the screen. Because of its drawbacks, the graphical-keyboard approach to pen-based input is often considered cumbersome, and is used in pen-based devices only as a fallback when character recognition fails or is insufficiently reliable.

The miniaturized mechanical keyboard overcomes some of the disadvantages of the graphical keyboard. However, the mechanical keyboard can be improved especially for thumb typing. The mechanical keyboard in U.S. Pat. No. 6,278,442 has two groups of keys that are arranged in rows that are arcing downward towards a lower portion of a handheld device. The keys in each group are all inclined at a fixed angle away from a normal. Such a layout of the keys suffers from disadvantages. Because of the fixed angle of inclination, there is a higher tendency for adjacent keys closer to the edges of the keyboard to be simultaneously hit. These keys appear to be more closely packed to an approaching thumb. The thumb comes into contact with a narrower portion of the keys. Moreover, a combination of rotating and retracting actions of the thumb is necessary for accessing keys in any row. Such a combination thumb action is considered by some users to be awkward.

### SUMMARY

According to an embodiment of the present invention, there is provided a keyboard suitable for a handheld device that includes a plurality of elongated keys arranged along at least one row. The row laterally extends from an origin. Each of the plurality of keys is inclined at an angle from a normal. The angle of incline of each of the plurality of keys increases with a distance between the key and the origin.

Preferably, each of the plurality of keys has an asymmetrical shape that is bulbous at one end and narrow at an opposite end.

According to another embodiment of the present invention, there is provided a handheld electronic device that include the above keyboard.

### BRIEF DESCRIPTION OF DRAWINGS

The invention will be better understood with reference to the drawings, in which:

FIG. 1 is a drawing showing a front view of the keys of an enlarged keyboard arranged according to an embodiment of the present invention;

FIGS. 2-4A are drawings similar to FIG. 1 showing different key layouts according to other embodiments of the present invention;

FIG. 4B is a drawing similar to FIG. 4A showing a thumb accessing keys on a top row of the keyboard in FIG. 4A; and

FIG. 5 is a drawing showing the front view of a handheld electronic device that includes the keyboard in FIG. 4A.

### DETAILED DESCRIPTION

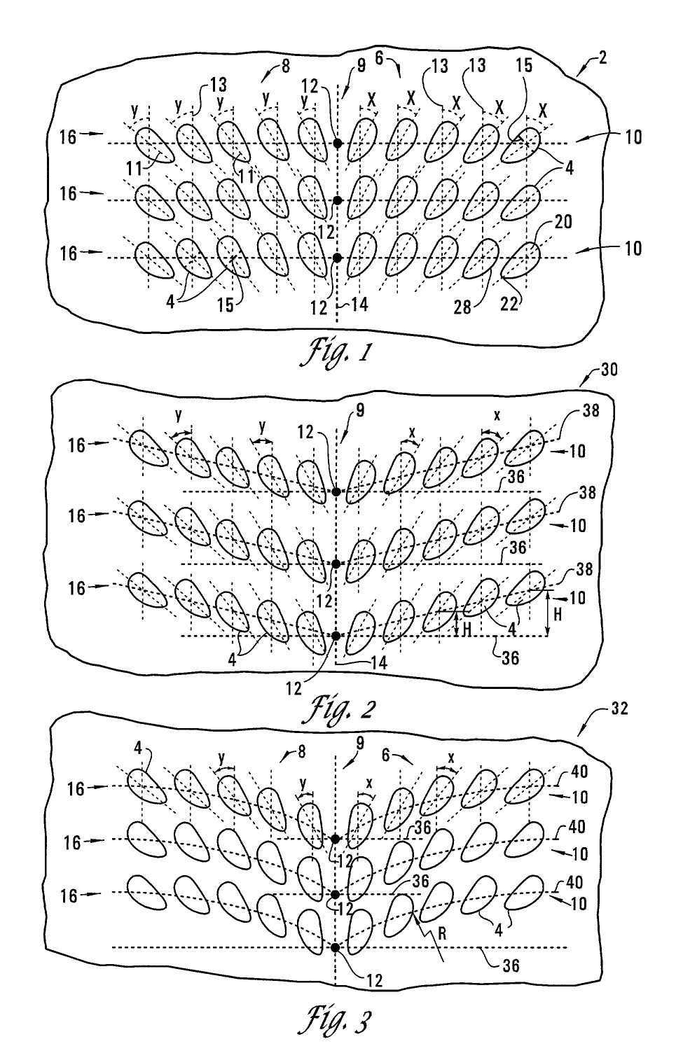

FIG. 1 shows an enlarged keyboard 2 with keys 4 arranged according to an embodiment of the present invention. The keys 4 are grouped into two groups including a first group 6 and a second group 8. The first group 6 includes a plurality of elongated keys 4 that are arranged along at least one row 10, preferably three rows 10 as shown in FIG. 1. The rows 10 are preferably equidistant apart. Each row 10 extends laterally in an x-y direction from an origin 12 located along a middle 9 of the keyboard 2. Each of the keys 4 in the first group 6 has a major axis 11 that is inclined at an angle X from and on a first side, for example to the right, of a normal 13 of each key 4. The normal 13 is a line parallel to a vertical line 14 through the origin 12. The angle of incline X of each key increases with a distance between the key and the origin 12. The angle of incline X may be between 0-90°. The centers of the keys 4 are preferably equidistant apart along each row 10.

The second group 8 of keys 4 is symmetrical to the first group 6 about the vertical line 14 through the middle 9 of the keyboard 2. Rows 16 in the second group 8 extend laterally in an opposite direction and each key 4 in the second group 8 has a major axis 11 that is inclined at an angle Y from and on a second side, opposite the first side, of a normal 13 of each key 4. Each of the keys 4 in the first group 6 and the second group 8 has a minor axis 15.

Preferably the two groups 6, 8 of keys 4 are designated as QWERTY keys (FIG. 5) similar to those found on standard keyboards. The elongated keys 4 may be oval-like in shape to reduce the overall space occupied by the keyboard 2 and to ensure that adjacent keys 4 are spaced sufficiently apart. The term elongated in this description should be construed to include any shape that has unequal axes 11, 15. Preferably, the keys 4 have a triangular-like shape that is asymmetrical about its axes as shown in FIG. 1. Any other shape that is bulbous at one end 20 and narrower at an opposite end 22 as shown in FIG. 1 may be used. Letters of the alphabet may be imprinted on the narrow end 22 of the keys 4 as shown in FIG. 5. One or more additional indicia representing numerals, punctuation marks, symbols and the like, may be imprinted on the bulbous end 20 of the keys 4. The keys 4 are preferably of a single size.

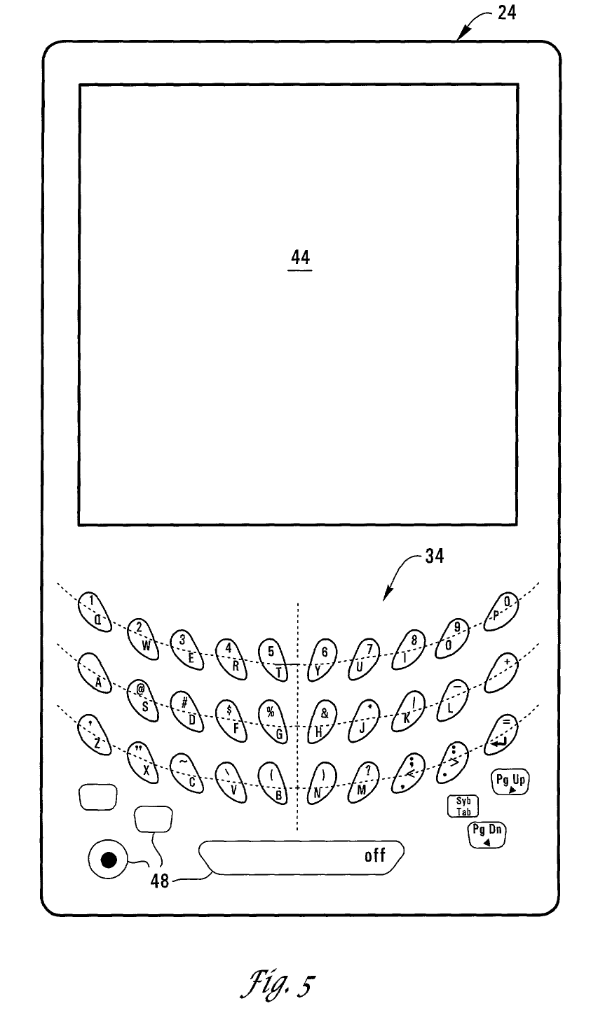

A personal digital assistant (PDA) 24 (FIG. 5) with a similar keyboard as the above keyboard 2 is typically supported between the fingers and a base of the thumbs of both hands to allows the thumbs to be used to access the individual keys 4. Tips of the thumbs are retracted toward, extended away and rotated about the base of the thumbs to access the keys 4. The layout of the keys 4 as described above allow the tips of the thumbs to come into contact with a wider portion 28 of the keys 4 as the tips of the thumbs are moved towards the keys 4 from a position of the base of the thumbs as shown in FIG. 4B.

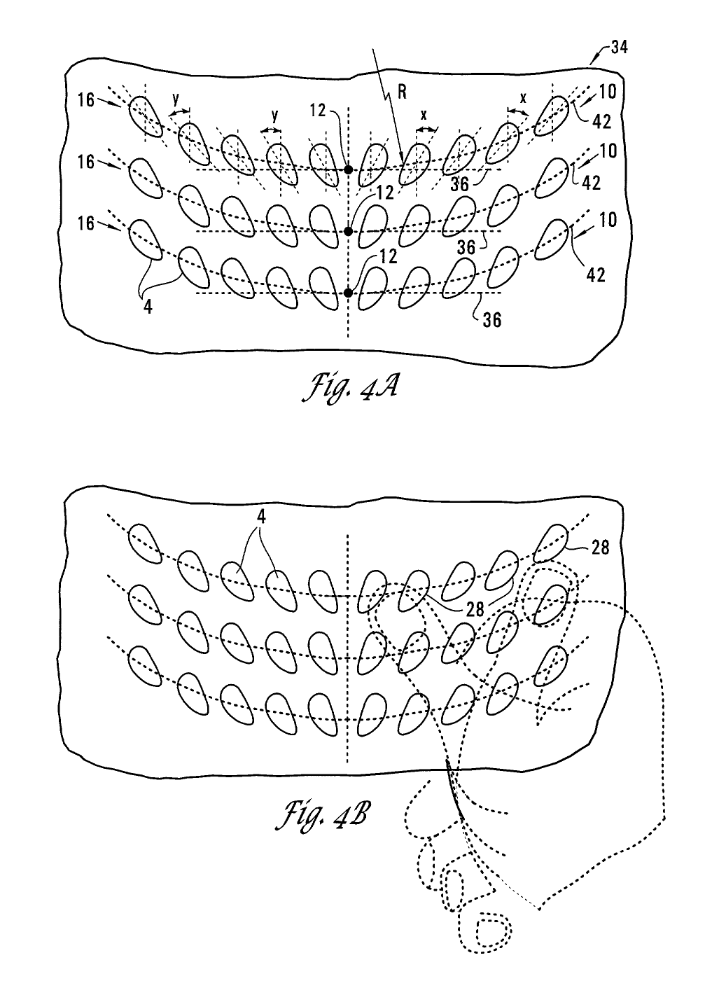

FIGS. 2-4A show keyboards 30-34 having different key layouts according to other embodiments of the present invention. The keyboards 30-34 facilitate access of the keys 4 by sweeping actions of the thumbs. Each row 10, 16 of keys 4 is tilted above a horizontal line 36 through its origin 12 so that each key 4 in the row 10, 16 is offset by a varying distance H above the horizontal line 36. The row 10, 16 may follow a straight line 38 that is inclined preferably at about 30 degrees from the horizontal line 36 as shown in FIG. 2. Alternatively, the row 10, 16 may follow an arc 40, 42, such as a convex 40 or a concave arc 42, above the horizontal line 36 as shown in FIGS. 3 and 4 respectively. The convex arc 40 and the concave arc 42 have a center that is below and above the row 10, 16 respectively. Although FIGS. 3 and 4 show offset arced rows 10, 16 as having a single radius R, the arced rows 10, 16 may have different radii. For example, the upper row in the keyboard 34 may have a smaller radius and the lower rows have an increasing radius. With convex arcs 40, adjoining rows 10, 16 of the two groups 6, 8 of keys 4 in FIG. 3 defines a winged configuration.

The front view of the PDA 24 in FIG. 5 includes the keyboard 34 in FIG. 4A. The PDA 24 includes a touch sensitive screen 44. The keyboard 34 in FIG. 5 includes a number of other keys 48.

Advantageously, the layout of keys 4 in the above-described keyboards 2, 30-34 is optimized for use by the thumbs. The increasing angle of inclination X, Y of the elongated keys 4 provides a larger area of contact 28 for an approaching thumb that is pivoted at a corner with respect to the keyboards 2, 30-34. Such a layout of keys 4 increases the accuracy of the thumb hitting a desired key. The tilted rows 10, 16 of the keyboards 30-34 provide a further ergonomic benefit. When the thumb is placed on a key 4 in a row 10, 16, a natural rotation of the thumb would bring it over the other keys 4 in the row 10, 16. The need to retract or extend the thumb and the fatigue associated therewith is reduced.

Although the present invention is described as implemented in a QUERTY keyboard 34 that is more suited for two thumb operation, the invention can be implemented in a keyboard with a reduced number of keys, such as keys 4 belonging to only the first group 6 of keys 4 in the above-described keyboards.

The keyboards 2, 30-34 are not to be construed to be limited to use on a PDA or a peripheral thereof. The keyboards may be provided on other handheld electronic devices such as two-way pagers, cellular phones and the like.

It is envisaged that variations to the keyboards are possible. For example, the keys on a keyboard may be of different sizes. The distance between adjacent keys on a row may change. The rows are also not necessarily equidistant apart.

I claim:

1. A keyboard for a handheld device comprising:
a plurality of elongated keys arranged along at least one row that laterally extends from an origin, each of the plurality of keys being inclined at an angle from and on a first side of a normal, wherein the angle of incline of each of the plurality of keys increases with distance between the key and the origin.

2. A keyboard according to claim 1, wherein the row is tilted above a horizontal line through the origin.

3. A keyboard according to claim 2, wherein the row follows a straight line that is inclined away from the horizontal line.

4. A keyboard according to claim 2, wherein the row follows an arc above the horizontal line.

5. A keyboard according to claim 4, wherein the row follows a concave arc.

6. A keyboard according to claim 5, wherein the at least one row includes a plurality of rows and wherein each row follows a concave arc of a different radius.

7. A keyboard according to claim 1, wherein each of the plurality of keys is offset by a varying distance above a horizontal line through the origin.

8. A keyboard according to claim 1, wherein the plurality of keys includes QWERTY designated keys.

9. A keyboard according to claim 1, wherein the plurality of keys is a first plurality of keys located on one side of a vertical line through the origin and wherein the keyboard further includes a second plurality of keys located on an opposite side of the vertical line, the second plurality of keys being arranged along at least one row that laterally extends from the origin, each of the second plurality of keys being inclined at an angle from and on a second side opposite the first side of a normal, wherein the angle of incline of each of the second plurality of keys increases with distance between the key and the origin.

10. A keyboard according to claim 9, wherein each row is tilted above a horizontal line through the origin.

11. A keyboard according to claim 10, wherein each row follows a straight line that is inclined away from the horizontal line.

12. A keyboard according to claim 10, wherein each row follows an arc above the horizontal line.

13. A keyboard according to claim 12, wherein each row follows a concave arc.

14. A keyboard according to claim 13, wherein adjoining rows on each side of the vertical line define a winged configuration.

15. A keyboard according to claim 1, wherein the plurality of keys belongs to a first group of keys located on one side of a vertical line through the origin and wherein the keyboard further includes a second group of keys that is symmetrical to the first group about the vertical line.

16. A keyboard according to claim 1, wherein each of the plurality of elongated keys is oval-like in shape.

17. A keyboard according to claim 1, wherein each of the plurality of keys has a shape that is bulbous at one end and narrower at an opposite end.

18. A keyboard according to claim 17, wherein each of the plurality of keys is asymmetrical about its axes.

19. A handheld electronic device having a keyboard that comprises:
a plurality of elongated keys arranged along at least one row that laterally extends from an origin, each of the plurality of keys being inclined at an angle from a normal, wherein the angle of incline of each of the plurality of keys increases with a distance between the key and the origin.

20. A keyboard for a handheld device comprising:
a plurality of elongated keys arranged along at least one row, wherein each key has an asymmetrical shape that is bulbous at one end and narrow at an opposite end.
